(19) United States
(12) Patent Application Publication
(10) Pub. No.: US 2014/0198103 A1
(43) Pub. Date: Jul. 17, 2014

(54) METHOD FOR POLYGON REDUCTION

(71) Applicant: DONYA LABS AB, Linkoping (SE)

(72) Inventors: Gustaf Johansson, STOCKHOLM (SE); Ulrik Lindahl, LJUNGSBRO (SE)

(73) Assignee: DONYA LABS AB, LINKOPING (SE)

(21) Appl. No.: 13/741,929

(22) Filed: Jan. 15, 2013

(51) Int. Cl. G06T 17/00

(52) U.S. Cl. CPC G06T 17/00
USPC 345/420

(57) ABSTRACT

The present invention generally relates to computer graphics and more specifically to a computer implemented method allowing for improvements in the creation of a polygon reduced three-dimensional graphics image. The present invention also relates to a corresponding image processing apparatus and a computer program product.

### TECHNICAL FIELD

The present invention generally relates to computer graphics and more specifically to a computer implemented method allowing for improvements in the creation of a polygon reduced three-dimensional graphics image. The present invention also relates to a corresponding image processing apparatus and a computer program product.

### BACKGROUND OF THE INVENTION

The creation and interactive visualization of artificial computer graphics (CG) environments is an important application in the field of computer graphics. Many applications, such as CAD, architectural walkthroughs, simulations, medical visualization and computer games include interactive navigation, i.e., being able to move around a computer model/scene at greater than 10 frames per second.

A common trend within the field of interactive computer graphics is the increasing amount of CG datasets. Large CG datasets require specialized graphics systems used to accelerate the process. However, models exist that cannot be rendered at interactive speeds even with current high-end computer hardware. The development of computer hardware is not likely to solve the described problems since the size of the CG data and the size of the secondary computer memory is increasing at faster rates than the development of thereto related hardware.

CG data is often represented using triangle meshes, or even more generally using a plurality of polygons. These meshes are typically not optimized for display or simulation performance. In most applications, the initial meshes can usually be replaced by optimized versions that could be approximations with far fewer faces, or containing other properties that make them more suited for particular applications such as mentioned above.

To prevent a decrease in calculation speed, an automatic technique of creating three-dimensional GC data with a small number of triangles/polygons in advance is often employed. However, in employing an automated process for polygon reduction, sometimes an undesirable visual error occurs, as perceived by a user. Generally, the graphical designer responsible for the specific GC dataset must then manually make suitable adjustments for achieving a visually appealing, but still polygon reduced, GC dataset. Accordingly, it would be desirable to allow for further automation of the polygon reduction process, reducing cost and possibly achieving a more optimized polygon reduced GC dataset. In addition, it would be desirable to further improve the visually appearance of such a polygon reduced GC dataset.

### SUMMARY OF THE INVENTION

According to a first aspect of the invention, the above is at least partly alleviated by a computer implemented method for polygon reduction of an initial three-dimensional graphics image, the method comprising obtaining the initial three-dimensional graphics image, the initial three-dimensional graphics image being represented as a polygon mesh, performing a polygon reduction process based on the initial three-dimensional graphics image resulting in a first polygon reduced representation of the initial three-dimensional graphics image, establishing a relationship between a plurality of points on a surface of the initial three-dimensional graphics image and a corresponding plurality of points on a surface of the first polygon reduced representation of the initial three-dimensional graphics image, determining an error distance in regards to each of the related points on the surfaces, respectively, and resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image.

By means of the invention, a further step is introduced in the polygon reduction process for forming a resulting polygon reduced representation of an initial three-dimensional graphic image. This is according to the invention provided by finding/establishing a relationship between a surface of the initial three-dimensional graphic image and a first polygon reduced representation of the initial three-dimensional graphic image. By making use of the established relationship it will be possible to determine an error distance being representative of a difference between the initial three-dimensional graphics image and the first polygon reduced representation of the initial three-dimensional graphic image. According to the invention, the first polygon reduced representation of the initial three-dimensional graphic image is resized such that at least one of a visual error as observer by a user, a maximum error distance or a mean error distance is reduced, where the resized version of the first polygon reduced representation of the initial three-dimensional graphic image will be provided as the resulting second polygon reduced representation of the initial three-dimensional graphics image.

Put differently, it is according to the invention possible to optimize the surface position locally on the reduced mesh using the above discussed relationship-points to find a direction where if moving the surface in this direction, the reduced mesh (i.e. first polygon reduced representation of the initial three-dimensional graphics image) will have a closer resemblance to the original mesh based on at least one of the above stated criteria.

In relation to the present invention, it should be understood that the expressions “surface of the initial three-dimensional graphics image” and “surface of the first polygon reduced representation of the initial three-dimensional graphics image” should be interpreted broadly. Specifically, any surface of the initial three-dimensional graphics image and the first polygon reduced representation of the initial three-dimensional graphics image may be selected, for example being an outer surface as well as an inner surface of the respective images. In addition, the actual plurality of point selected on the respective surface may include a large as well as only a limited number of points.

Still further, the expression “establishing a relationship” should within the context of the invention be interpreted as relating to suitably related points on the different surfaces of the respective images (initial and polygon reduced representation). As such, a point on the surface of the initial three-dimensional graphics image may once a polygon reduction process has been performed be positioned slightly different in relation to the corresponding surface of the polygon reduced representation. However, the different points still have an obvious relation.

In addition, typically the initial, the first and the second three-dimensional graphics image is a polygonal image comprising a plurality of polygons forming a 3-D computer graphics image.

According to the invention, the above disclosed method may be performed for only a selected portion when performing a polygon reduction process in relation to initial three-dimensional graphics image. That is, the inventive method may essentially be included as a (e.g. integrated) step in relation to performing the polygon reduction process, wherein the inventive method (i.e. in relation to the resizing) may be performed iteratively, for e.g. selected smaller portions of the initial three-dimensional graphics image, once the polygon reduction process is performed.

In a preferred embodiment of the invention, a relationship between the reduction of the maximum error distance and the mean error distance is determined as a parameter provided by a user operating the computer implemented method. That is, not only may a visual error as observer by a user, a maximum error distance or a mean error distance be reduced, it may according to the invention be possible to set a relationship between at least the maximum error distance and the mean error distance. As such, a user may in some sense select to allow the method to take into account a possible trade-off between these two possible errors. As an example, it may for example be possible to set parameters allowing all maximum error distances exceeding predetermined threshold to be reduced, whereas at the same time (taking into account the predetermined threshold for the maximum errors) the mean error distance is kept as low as possible.

In a possible embodiment, a first portion of the plurality of determined error distances are given a higher weight as compared a second portion of the plurality of determined error distances. That is, it may according to the invention also be possible to set different parameters for different portions of the initial three-dimensional graphics image. As an example, in case the initial three-dimensional graphics image illustrates a representation of a person, the face of the person may be given higher priority as compared to remaining parts of the person. Additionally, it may be possible to give a higher weight to error distances above a predetermined, and possibly user initiated, threshold. As such, a large error distance may have higher impact on reduction based on e.g. the maximum error distance and/or the mean error distance as compared to a small error distance being below the predefined threshold.

In a preferred embodiment, the relationship between the respective surfaces may be determined using at least one of ray casting between the initial three-dimensional graphics image and the first polygon reduced representation of the initial three-dimensional graphics image (e.g. where the points may be vertex points in relation to the respective surfaces), a polygon relationship between the initial three-dimensional graphics image first polygon reduced representation of the initial three-dimensional graphics image, and a texture relation between the initial three-dimensional graphics image first polygon reduced representation of the initial three-dimensional graphics image. In addition, it may be possible to use a common parameterization for both the original and the reduced polygonal mesh for finding the relationship/corresponding points between the two surfaces. This common parameterization could for example be a 2D-parameterization, like a UV atlas. Still further, it may be possible to establish the relationship using a volumetric grid to establish a correspondence between the original and the reduced surface. The discussed methods can be used either just once, on the whole geometry, or in iterative steps, locally, for each step during the reduction process, and have a surface-relationship/correspondence built up successively during the reduction process. Further possibilities exist and are within the scope of the invention

Using the above discussed relationship it may be possible to map a separate texture layer of the initial three-dimensional graphics image to a corresponding position of the second polygon reduced representation of the initial three-dimensional graphics image. Accordingly, further use may be made of the relationship between the initial and the resulting polygon reduced representation such that an appealing end result may be provided.

According to another aspect of the present invention there is provided an image processing apparatus for polygon reduction of an initial three-dimensional graphics image, comprising means for obtaining the initial three-dimensional graphics image, the initial three-dimensional graphics image being represented as a polygon mesh, means for performing a polygon reduction process based on the initial three-dimensional graphics image resulting in a first polygon reduced representation of the initial three-dimensional graphics image, means for establishing a relationship between a plurality of points on a surface of the initial three-dimensional graphics image and a corresponding plurality of points on a surface of the first polygon reduced representation of the initial three-dimensional graphics image, means for determining an error distance in regards to each of the related points on the surfaces, respectively, and means for resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image. This aspect of the invention provides similar advantages as discussed above.

The invention is preferably provided on a computer-readable storage medium storing a program which causes a computer to execute an image processing method as discussed above.

According to further aspect of the invention there is provided a computer readable medium having stored thereon computer program means for controlling an image processing apparatus configured for performing a polygon reduction of an initial three-dimensional graphics image, wherein the computer program product comprises code for obtaining the initial three-dimensional graphics image, the initial three-dimensional graphics image being represented as a polygon mesh, code for performing a polygon reduction process based on the initial three-dimensional graphics image resulting in a first polygon reduced representation of the initial three-dimensional graphics image, code for establishing a relationship between a plurality of points on a surface of the initial three-dimensional graphics image and a corresponding plurality of points on a surface of the first polygon reduced representation of the initial three-dimensional graphics image, code for determining an error distance in regards to each of the related points on the surfaces, respectively, and code for resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image. Also this aspect of the invention provides similar advantages as discussed above.

The image processing apparatus is preferably a server, a general computer, a micro processor or any other type of computing device. Similarly, the computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIGS. 1a and 1b show an example of polygon based three-dimensional graphics image;

FIG. 2 illustrates a conceptual image processing system according to a currently preferred embodiment of the invention;

FIG. 3 shows a flow chart of method steps according to an embodiment of the invention, and

FIG. 4 provides intermediate visualizations of the graphics objects generated at different steps of the inventive method.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

In a system with a three-dimensional graphics accelerator, an application program generates three-dimensional geometry data including information corresponding to points on the surface of a three-dimensional graphical image. These points are usable as vertices of polygons which, when connected, may be rendered to form a representation of the graphical image. Typically, the application program transfers the three-dimensional geometry data to a graphics accelerator and renders the encoded polygons on e.g. a computer screen.

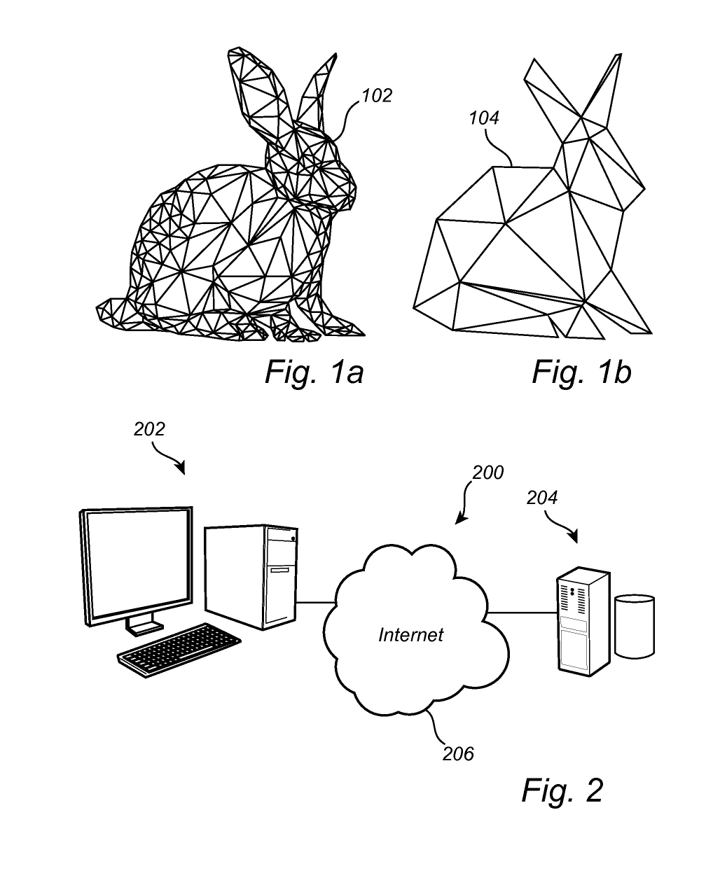

The process of connecting three-dimensional vertices to form a representation of a graphical image may be referred to as creating a polygon mesh. FIGS. 1a and 1b illustrate two different versions of an exemplary three-dimensional graphics image, in the form of a “bunny”, which have been tiled into such a polygon mesh. The first version of the bunny 102 is represented by a large plurality of polygons, whereas the second version of the bunny 104 is represented by a reduced number of polygons as compared to the first version of the bunny 102. The polygon reduction process typically takes place by removing vertices and edges that constitute the mesh model 102, where different levels of polygon reduction may be selected based on a predetermined desired ratio (i.e. original in comparison to the reduced image), pixel based, or based on a polygon budget for the specific image (or object).

As discussed above, the present invention generally relates to a computer implemented method for optimizing polygon reduction of an initial three-dimensional graphics image, specifically taking into account a visual error metric generated based on a difference between an original image and a polygon reduced representation of the original image. Accordingly, the original image could be corresponding to the first version of the bunny 102, whereas the polygon reduced representation could be corresponding to the second version of the bunny 104.

The general concept of the present invention may typically be implemented in an image processing apparatus including a general purpose processor (e.g. a user controlled personal computer), an application specific processor, a circuit containing processing components, a group of distributed processing components, a group of distributed computers configured for processing, etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

However, as is shown in the conceptual illustration provided in FIGS. 1a and 1b, the general functionality of the inventive image processing apparatus may also and/or alternatively be provided in a distributed environment, for example by means of an image processing system 200. In such an implementation, the image processing system 200 may be configured to comprise a user controlled computing device 202 (e.g. the user controlled personal computer) connected to a server/database arrangement 204 over the Internet 206. Accordingly, resources for performing the inventive concept may typically be divided between the computing device 202 and the server/database arrangement 204.

Further to reducing the hardware constrains on the user controlled computing device 202, it would according to the invention be possible to e.g. “on-demand” provide a user/customer with the functionality provided by means of the inventive concept. As an example, a user wanting to generate a polygon reduced image based on an original three-dimensional graphics image may, through a user interface shown on the computing device 202, access a computer implementation of the optimizing polygon reduction running on the server 204. Alternatively, the computing device 202 may be provided with software for producing the original image (such as for example 3D Studio Max, Maya, etc.), where the software running on the computing device 202 is adapted to access/interact with (by means of e.g. an API and “on-demand”, as a subscription, as a fixed service, etc.) a computer implementation of the inventive concept running on the server 204.

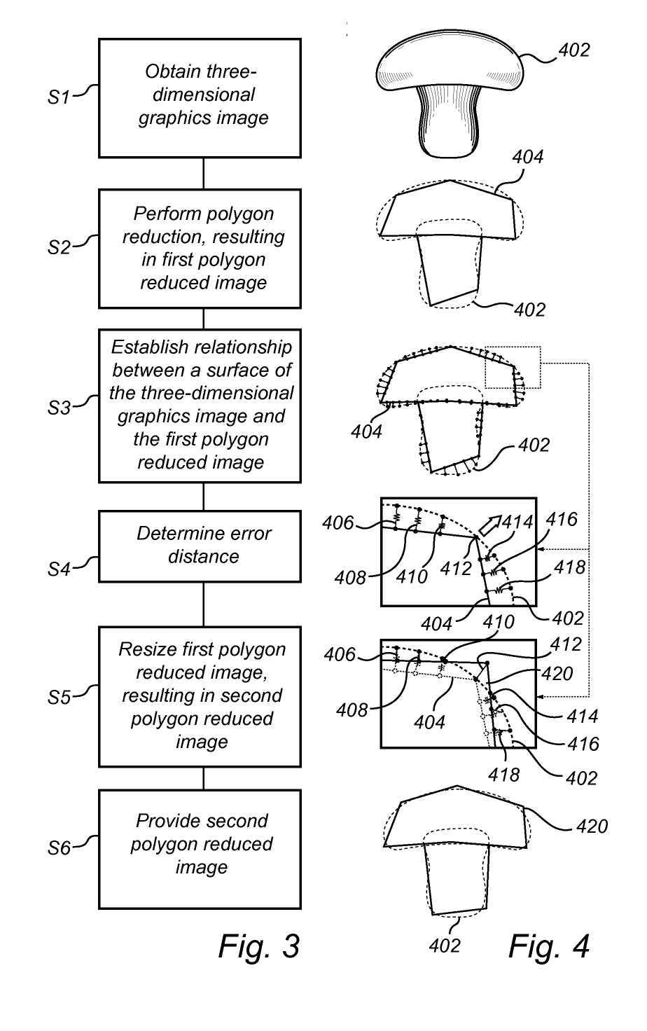

In performing the inventive concept, with further reference to FIGS. 3 and 4, the process starts with an image processing apparatus, e.g. in the form of the combined image processing system 200 controlled by the user of the computing device 202, obtains, S1, a single (one or a plurality of) three-dimensional graphics image(s) 402, represented as an initial or original three-dimensional graphics image/object. Following the computing device 202 obtaining the initial image 402, a polygon reduction process is performed, S2, resulting in a first three-dimensional graphics image 404 being a first polygon reduced representation of the initial three-dimensional graphics image 402. The polygon reduction process may be any type of present or future polygon reduction process known to the skilled person in the art. For example, the polygon reduction process may be adapted to have a targeted polygon budget, e.g. with a fixed or a range of polygons towards which the three-dimensional graphics image preferably should be reduced.

Accordingly, following the step of performing first polygon reduction process, a relationship is established, S3, between a surface of the initial three-dimensional graphics image 402 and a corresponding surface of the first polygon reduced three-dimensional graphics image 404. As discussed above, the relationship may be apparent, e.g. made in connection to corresponding points at the different surfaces (e.g. where the points may be vertex points in relation to the respective surfaces), or may be established using e.g. ray casting between the initial three-dimensional graphics image and the first polygon reduced representation of the initial three-dimensional graphics image or a texture relation (texture, color, etc.) between the initial three-dimensional graphics image first polygon reduced representation of the initial three-dimensional graphics image. As discussed above, it may additionally be possible to use a common parameterization for both the original and the reduced polygonal mesh for finding the relationship/corresponding points between the two surfaces. This common parameterization could for example be a 2D-parameterization, like a UV atlas. Still further, it may be possible to establish the relationship using a volumetric grid to establish a correspondence between the original and the reduced surface. The discussed methods can be used either just once, on the whole geometry, or in iterative steps, locally, for each step during the reduction process, and have a surface-relationship/correspondence built up successively during the reduction process.

Based on the established relationship, a plurality of error distances 406, 408, 410, 412, 414, 416, 418 are determined, S4, for a plurality of points of the respective surfaces. As mentioned above, different portions of the determined error distances 406, 408, 410, 412, 414, 416, 418 may be given different weights, where for example a large error distance may be given a higher weight as compared to a smaller error distance, where the definition of if an error distance is large or small depends on a predetermined threshold provided in relation to the error distances.

From an explanation perspective it may be possible to illustrate the error distances 406, 408, 410, 412, 414, 416, 418 (also denoted relationship-points) as springs, where each spring acts as a local force upon the reduced mesh, and in e.g. iterative steps drags the surface of the reduced mesh into a position where the force of all the local springs on the mesh is at equilibrium. This force may for example be calculated using for example Hooke's law, or a modified version. The force of each spring could for example be multiplied by the size of its area of influence. It is of course possible to use other ways of calculating the “spring force”, including but not limited to applying non-linear springs, where the force applied is not proportional to the distance D between the reduced mesh and the original mesh, but instead the square-root of D, or the square of D or some power of D.

Following determining the error distances 406, 408, 410, 412, 414, 416, 418, the first polygon reduced three-dimensional graphics image 404 is resized, S5, taking into account possible weights set to the different error distances 406, 408, 410, 412, 414, 416, 418. As can be seen from FIG. 4, this may actually lead to some of the error distances, e.g. the error distance 412, being larger for the resized/second polygon reduced three-dimensional graphics image 420, than what was present when the same error distance 412 was determined in relation to the first polygon reduced three-dimensional graphics image 404. In any case, depending on the parameters set for the resizing, e.g. the visual error as observer by the user, the maximum error distance or the mean error distance may be reduced and a more appealing polygon reduced representation may be provided, S6, to the user.

In summary, the present invention relates to a computer implemented method allowing for improvements in the creation of a polygon reduced three-dimensional graphics. By means of the invention, a further step is introduced in the polygon reduction process for forming a resulting polygon reduced representation of an initial three-dimensional graphic image. According to the invention, the resulting polygon reduced representation is adapted to be provided as an improved representation of a first polygon reduced representation of the initial three-dimensional graphic image. This is according to the invention provided by finding/establishing a relationship between a surface of the initial three-dimensional graphic image and a first polygon reduced representation of the initial three-dimensional graphic image. By making use of the established relationship it will be possible to determine an error distance being representative of a difference between the initial three-dimensional graphics image and the first polygon reduced representation of the initial three-dimensional graphic image.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. Furthermore, in the claims, the word “comprising” does not exclude other elements or steps, and the indefinite article “a” or “an” does not exclude a plurality.

1. A computer implemented method for polygon reduction of an initial three-dimensional graphics image, the method comprising:
obtaining the initial three-dimensional graphics image, the initial three-dimensional graphics image being represented as a polygon mesh;
performing a polygon reduction process based on the initial three-dimensional graphics image resulting in a first polygon reduced representation of the initial three-dimensional graphics image;
establishing a relationship between a plurality of points on a surface of the initial three-dimensional graphics image and a corresponding plurality of points on a surface of the first polygon reduced representation of the initial three-dimensional graphics image;
determining an error distance in regards to each of the related points on the surfaces, respectively; and
resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image.

2. The method of claim 1, wherein a relationship between the reduction of the maximum error distance and the mean error distance is determined as a parameter provided by a user operating the computer implemented method.

3. The method of claim 1, wherein a first portion of the plurality of determined error distances are given a higher weight as compared a second portion of the plurality of determined error distances.

4. The method of claim 1, wherein the relationship between the respective surfaces is determined using at least one of ray casting between the initial three-dimensional graphics image and the first polygon reduced representation of the initial three-dimensional graphics image, a polygon relationship between the initial three-dimensional graphics image first polygon reduced representation of the initial three-dimensional graphics image, a texture relation between the initial three-dimensional graphics image first polygon reduced representation of the initial three-dimensional graphics image, a common parameterization for the initial three-dimensional graphics image and the first polygon reduced representation of the initial three-dimensional graphics image, and using a volumetric grid to establish a correspondence between the initial three-dimensional graphics image and the first polygon reduced representation of the initial three-dimensional graphics image.

5. The method of claim 1, further comprising the step of mapping a texture of the initial three-dimensional graphics image to a corresponding position of the second polygon reduced representation of the initial three-dimensional graphics image based on the established relationship between points on the respective surfaces.

6. The method of claim 1, wherein the initial, the first and the second three-dimensional graphics image is a polygonal image comprising a plurality of polygons forming a 3-D computer graphics image.

7. An image processing apparatus for polygon reduction of an initial three-dimensional graphics image, comprising:
means for obtaining the initial three-dimensional graphics image, the initial three-dimensional graphics image being represented as a polygon mesh;
means for performing a polygon reduction process based on the initial three-dimensional graphics image resulting in a first polygon reduced representation of the initial three-dimensional graphics image;
means for establishing a relationship between a plurality of points on a surface of the initial three-dimensional graphics image and a corresponding plurality of points on a surface of the first polygon reduced representation of the initial three-dimensional graphics image;
means for determining an error distance in regards to each of the related points on the surfaces, respectively; and
means for resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image.

8. The image processing apparatus of claim 7, wherein a relationship between the reduction of the maximum error distance and the mean error distance is determined as a parameter provided by a user operating the computer implemented method.

9. The image processing apparatus of claim 7, wherein a first portion of the plurality of determined error distances are given a higher weight as compared a second portion of the plurality of determined error distances.

10. The image processing apparatus of claim 7, wherein the relationship between the respective surfaces is determined using at least one of ray casting between the initial three-dimensional graphics image and the first polygon reduced representation of the initial three-dimensional graphics image, a polygon relationship between the initial three-dimensional graphics image first polygon reduced representation of the initial three-dimensional graphics image, a texture relation between the initial three-dimensional graphics image first polygon reduced representation of the initial three-dimensional graphics image, a common parameterization for the initial three-dimensional graphics image and the first polygon reduced representation of the initial three-dimensional graphics image, and using a volumetric grid to establish a correspondence between the initial three-dimensional graphics image and the first polygon reduced representation of the initial three-dimensional graphics image.

11. The image processing apparatus of claim 7, further comprising means for mapping a texture of the initial three-dimensional graphics image to a corresponding position of the second polygon reduced representation of the initial three-dimensional graphics image based on the established relationship between points on the respective surfaces.

12. The image processing apparatus of claim 7, wherein the initial, the first and the second three-dimensional graphics image is a polygonal image comprising a plurality of polygons forming a 3-D computer graphics image.

13. A computer-readable storage medium storing a program which causes a computer to execute the image processing method of claim 1.

14. A computer program product comprising a computer readable medium having stored thereon computer program means for controlling an image processing apparatus configured for performing a polygon reduction of an initial three-dimensional graphics image, wherein the computer program product comprises:
code for obtaining the initial three-dimensional graphics image, the initial three-dimensional graphics image being represented as a polygon mesh;
code for performing a polygon reduction process based on the initial three-dimensional graphics image resulting in a first polygon reduced representation of the initial three-dimensional graphics image;
code for establishing a relationship between a plurality of points on a surface of the initial three-dimensional graphics image and a corresponding plurality of points on a surface of the first polygon reduced representation of the initial three-dimensional graphics image;
code for determining an error distance in regards to each of the related points on the surfaces, respectively; and
code for resizing the first polygon reduced representation of the initial three-dimensional graphics image such that at least one of a visual error as observer by a user, a maximum error distance or a mean error distance is reduced, resulting in a second polygon reduced representation of the initial three-dimensional graphics image.
